(19) United States
(12) Patent Application Publication
(10) Pub. No.: US 2026/0323202 A1
(43) Pub. Date: Oct. 15, 2026

(54) METHODS OF CANCELLING VIBRATIONS FROM SPEAKERS TRANSDUCERS IN TRACKING SYSTEMS

(71) Applicant: Valve Corporation, Bellevue, WA (US)

(72) Inventors: Joy E. Lyons, Lake Forest Park, WA (US); William Winters, Portland, OR (US)

(21) Appl. No.: 19/176,450

(22) Filed: Apr. 11, 2025

(51) Int. Cl. H04R 1/28; G02B 27/01; G10K 11/178; H04R 1/02; H04R 1/40

(52) U.S. Cl. CPC H04R 1/2873; G02B 27/0176; G02B 27/0179; G10K 11/17853; H04R 1/028; H04R 1/2896; H04R 1/403; G02B 2027/0187; H04R 2499/11; H04R 2499/15

(57) ABSTRACT

Described herein are force canceling speaker transducers configured to reduce vibrations that would otherwise propagate through a device housing during audio output. An example head-mounted display (HMD) includes a housing, and a pair of speaker transducers mounted in the housing. The pair of speaker transducers includes one speaker transducer having a front side facing a first on-axis direction that is fixed relative to the housing of the HMD, and another speaker transducer having a front side facing a second on-axis direction that is fixed relative to the housing of the HMD and that is rotated relative to the first on-axis direction by a first angle within a range of about 120 to 240 degrees.

### BACKGROUND

Head-mounted displays (HMDs), such as virtual reality (VR) headsets, are used both within and outside of the video game industry. HMDs may use a tracking system that leverages one or more sensors (e.g., an inertial measurement unit(s) (IMU(s)), a camera(s), infrared (IR) sensors, etc.) to track, among other things, a pose of the HMD in three-dimensional (3D) space. A VR headset, for instance, may be tracked so that the content (e.g., video content, audio content, etc.) is rendered in a manner that is consistent with the user's head movement, which provides an immersive VR experience for the user of the VR headset. Video content is presented as a series of images on a display panel(s) of the HMD, while audio content is typically output via headphones or speakers.

### BRIEF DESCRIPTION OF THE DRAWINGS

The detailed description is described with reference to the accompanying drawings. In the figures, the left-most digit(s) of a reference number identifies the figure in which the reference number first appears. The use of the same reference numbers in different figures indicates similar or identical components or features.

FIG. 1 illustrates an example HMD that includes force canceling speaker transducers mounted in a housing of the HMD, in accordance with embodiments disclosed herein.

FIG. 2 is a diagram illustrating a range of angles by which a pair of speaker transducers can be rotationally displaced from one another for canceling forces generated by the individual speaker transducers during audio output, in accordance with embodiments disclosed herein.

FIG. 3 is a diagram illustrating that a first pair of speaker transducers are positioned in the HMD to be substantially equidistant from a left ear of a user of the HMD and that a second pair of speaker transducers are positioned in the HMD to be substantially equidistant from a right ear of the user, when the HMD is worn on the user's head, in accordance with embodiments disclosed herein.

FIG. 4 illustrates diagrams of different implementations of speaker transducers, and the effects of those implementations on sound output and force/vibration balancing, in accordance with embodiments disclosed herein.

FIG. 5A illustrates a top view and a side view of an example baffle of the housing of the HMD in which a pair of speaker transducers are configured to be mounted, in accordance with embodiments disclosed herein.

FIG. 5B illustrates a side view of the baffle of FIG. 5A with a pair of speaker transducers mounted to the baffle, in accordance with embodiments disclosed herein.

FIG. 6 illustrates example components of a HMD system in which the embodiments disclosed herein can be implemented, in accordance with embodiments disclosed herein.

FIG. 7 is a diagram of an example signal processing approach that can be used in addition to, or in lieu of, the disclosed force canceling speaker transducers for mitigating, if not eliminating, the interference from the speaker transducers during audio output, in accordance with embodiments disclosed herein.

### DETAILED DESCRIPTION

IMUs are used to track the position and/or the orientation of electronic devices in 3D space. An IMU may be configured to generate data based on electrical signals received from one or more of an accelerometer(s), a gyroscope(s), a magnetometer(s), and/or other sensors. In some examples disclosed herein, a HMD is configured to use data generated by an IMU(s) of the HMD (potentially in conjunction with additional data from additional components, such as a camera(s) of the HMD) to determine poses of the HMD over time, which is sometimes referred to herein as “tracking” the HMD. In some examples, a predicted pose of the HMD is used in a rendering algorithm to render content (e.g., video content, audio content, etc.) in a manner that is consistent with the user's head pose at a time when the user perceives (e.g., sees, hears, etc.) the rendered content.

The HMD disclosed herein includes speaker transducers embedded, or otherwise mounted, in a housing of the HMD and configured to emit sound that corresponds to the audio content. As used herein, a “speaker transducer” refers to a device that converts electrical signals from an electrical source into sound for a listener (e.g., a user of the HMD in which the speaker transducer is mounted). As used herein, “speaker driver” may be used interchangeably with “speaker transducer.” Mounting the speaker transducers in the housing of the HMD allows for manufacturing a HMD with a more compact form factor, as compared to a HMD with, say, headphones that are placed in, on, or directly over the ears. During audio output, movable components (e.g., a voice coil, a diaphragm, etc.) of the speaker transducer move back and forth along an axis of motion to emit sound (e.g., the motion of the diaphragm moves air particles to create the sound). However, this motion also generates vibrations that can propagate through the housing of the HMD, and because the IMU(s) is mounted in the housing of the HMD, those vibrations may be detected by the IMU(s). That is, the vibrations generated as a by-product of sound emitted by the speaker transducer can be exhibited in the data generated by the IMU(s); specifically, in the accelerometer data and in the gyroscope data. This IMU-generated data that corresponds to the vibrations generated by the speaker transducer can be interpreted by the tracking system of the HMD as spurious head movement, which can interfere with the ability to accurately track the HMD and/or to render video content (e.g., images) in a smooth, stable manner via the HMD. For example, such interference from the speaker transducers can be exhibited in the rendered video content as jitter, where the rendered video content jitters in synchronization with the sound being emitted by the speaker transducers, regardless of whether the user is moving their head or not.

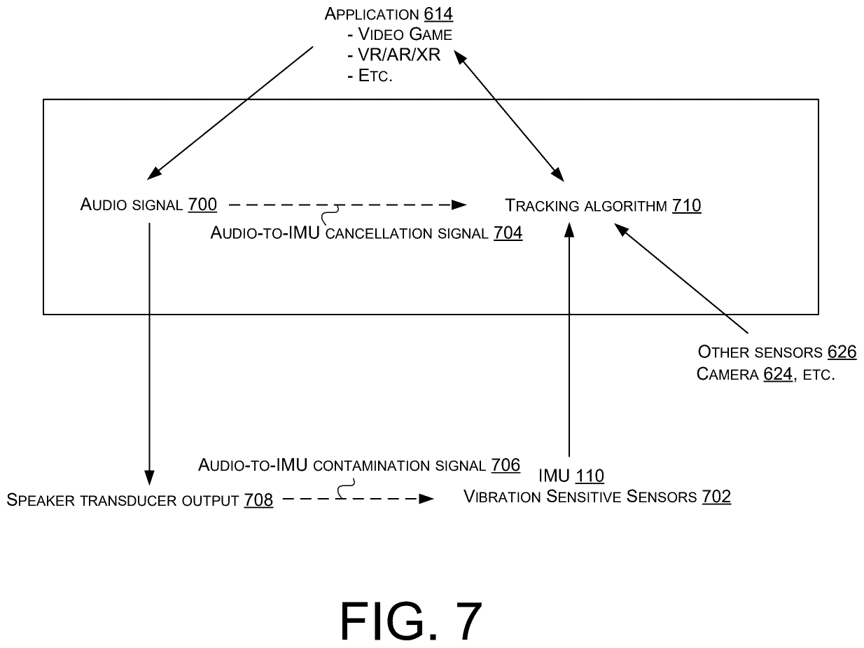

Various technical solutions to improve and enhance a HMD and/or other devices (e.g., other types of electronic devices configured to be tracked at least in part using an IMU(s) of the electronic device) are contemplated herein. For example, one or more pieces of compliant material (e.g., rubber, viscoelastic polymer) can be added to the housing of the HMD to dampen the forces generated by the individual speaker transducers during audio output, thereby reducing, if not eliminating, the interference from the speaker transducers during audio output. However, compliant material can cause a lagging response of the IMU to the target head-motion resulting in poor tracking, and it can add volume and weight to the housing. As another example, the IMU(s) of the HMD may be mounted in the housing of the HMD differently, such as by mounting the IMU(s) at a different position that is farther away from the speaker transducers and/or by mounting the IMU(s) in a different orientation. However, mounting the IMU(s) differently, especially in an electronic device with a relatively small form factor, may have minimal impact on reducing interference from the speaker transducers during audio output because the vibrations transfer through the rigid structure without significant attenuation losses. Yet another example approach is a signal processing approach where data generated by the IMU(s) is filtered to remove any portion of the IMU-generated data that is attributable to the vibrations generated by the speaker transducers of the HMD. Hence, a signal processing approach (e.g., See FIG. 7) can be used in addition to, or in lieu of, the disclosed force canceling speaker transducers for mitigating, if not eliminating, the interference from the speaker transducers during audio output.

Described herein are, among other things, devices and systems that include force canceling speaker transducers configured to reduce, if not eliminate, vibrations that would otherwise propagate through a device housing during audio output. In some examples, respective positive motion vectors of a pair of speaker transducers (which are mounted in a housing of an electronic device) are rotationally displaced from one another by an angle within a range of about 120 to 240 degrees. This rotational (or angular) displacement of the pair of speaker transducers cancels forces generated by the individual speaker transducers during audio output that would otherwise cause vibrations. In this manner, the force canceling speaker transducers can be implemented in a HMD to address the above-described technical problem by reducing, if not eliminating, a portion of the IMU-generated data that is attributable to the forces generated by the individual speaker transducers during audio output. In some examples, this reduction of the speaker transducer-generated forces is to an extent that there is no perceptible jitter from these forces in the rendered video content of the HMD. In some examples, the speaker transducer-generated forces cancel perfectly, which results in eliminating any jitter in the rendered video content that would have been attributable to the vibrations generated by the speaker transducers during audio output. In other words, a HMD with the disclosed force canceling speaker transducers is able to render stable, smooth video content without any perceptible jitter.

An example HMD in accordance with embodiments disclosed herein includes a housing. A first speaker transducer and a second speaker transducer are mounted in the housing. The first speaker transducer has a front side facing a first on-axis direction that is fixed relative to the housing of the HMD. The second speaker transducer also has a front side facing a second on-axis direction that is fixed relative to the housing of the HMD, but different than the first on-axis direction. The second on-axis direction is different than the first on-axis direction in that the second on-axis direction is rotated relative to the first on-axis direction by a first angle within a range of about 120 to 240 degrees. In this configuration, forces generated by the first and second speaker transducers during audio output are canceled to reduce vibrations that are transferred through the housing of the HMD. In a HMD with an IMU(s), the vibrations cancel at the IMU(s), but the audio remains in phase at the listening location (e.g., the ear of the user wearing the HMD).

In some examples, the first and second speaker transducers are configured to emit sound for a left ear of the user of the HMD. Accordingly, the housing may have a left side and a right side (e.g., the left side of the housing configured to be disposed at a left side of a head of a user of the HMD and the right side of the housing is configured to be disposed at a right side of the user's head), and the first speaker transducer and the second speaker transducer are mounted in the housing at the left side of the housing, while a third speaker transducer and a fourth speaker transducer are mounted in the housing at the right side of the housing and configured to emit sound for a right ear of the user of the HMD. The third speaker transducer has a front side facing a third on-axis direction that is fixed relative to the housing of the HMD. The fourth speaker transducer also has a front side facing a fourth on-axis direction that is fixed relative to the housing, but different than the third on-axis direction. The fourth on-axis direction is different than the third on-axis direction in that the fourth on-axis direction is rotated relative to the third on-axis direction by a second angle within the range of about 120 to 240 degrees. Accordingly, forces generated by the third and fourth speaker transducers during audio output are canceled to reduce vibrations that are transferred through the housing of the HMD, as described in more detail below.

The force canceling speaker transducers described herein provide various technical benefits. Firstly, mitigating vibrations caused by speaker transducers of an electronic device can extend the lifespan of the electronic device because vibrations, over an extended period of time, may cause joints, screws, adhesive, and/or other fastening elements to loosen or degrade, causing more wear on the electronic device. Additionally, or alternatively, mitigating vibrations caused by speaker transducers can improve a user experience by reducing the amount of buzzing that is felt and/or heard by the user of the electronic device, thereby mitigating disturbances that the user may find unpleasant or annoying. In a HMD, this can make the HMD more comfortable and enjoyable to wear and use for longer periods of time. Additionally, because multiple speaker transducers are to be implemented in an electronic device to cancel the forces generated during audio output (e.g., where one speaker transducer cancels the forces generated by the other speaker transducer, and vice versa), electronic devices that implement the disclosed force canceling speaker transducers can benefit from a smaller, more compact form factor, as compared to an electronic device that uses a single, larger speaker transducer to emit sound with similar audio quality. In view of the above-described technical benefits, it is to be appreciated that the force canceling speaker transducers disclosed herein can be implemented in any electronic device configured to output sound, regardless of whether the electronic device is to be tracked in part using an IMU(s). Accordingly, in some examples, an electronic device (e.g., a HMD) may be devoid of an IMU, or may be tracked using other types of tracking devices, such as cameras, IR sensors, etc., yet the electronic device (e.g., the HMD) may nevertheless benefit from the disclosed force canceling speaker transducers.

In an electronic device that includes an IMU(s) (e.g., for tracking purposes), such as a HMD with an IMU(s) mounted in the housing of the HMD and used for tracking the poses of the HMD over time, the force canceling speaker transducers reduce, if not eliminate, vibrations that are transferred through the device housing so that they are not exhibited in the data generated by the IMU(s), or at least to reduce the extent to which the vibrations are exhibited in the IMU-generated data. Using standard deviation as a metric for a change from a nominal value in a stationary device, depending on the rotational (or angular) displacement of the pair of speaker transducers disclosed herein, the disclosed solution reduces the standard deviation of the accelerometer data and the gyroscope data from the IMU (with stepped sine test signal) by a factor within a range of 5× to 16×. This means that the amount of vibration introduced into the device housing by the speaker transducers is significantly lower, as compared to an electronic device with a single, larger speaker transducer, or a device with multiple speaker transducers that are not rotationally (or angularly) displaced in the manners disclosed herein. In a HMD that uses an IMU(s) for tracking the HMD and rendering content that is consistent with the pose of the user's head at a time that the user perceives the rendered content, the video content that is rendered (e.g., a series of images displayed) on the display panel(s) of the HMD is stable and smooth during audio output from the force canceling speaker transducers that are mounted in the housing of the HMD. In other words, the force canceling speaker transducers disclosed herein do not cause any perceptible jitter (e.g., jitter, if any, is inconspicuous from the user's perspective) in the video content that is rendered on the display panel(s) of the HMD.

Although the examples described herein pertain to a HMD, it is to be appreciated that the force canceling speaker transducers can be implemented in any electronic device with an IMU(s) mounted in the housing of the electronic device. Examples of other types of electronic devices that may benefit from implementing the force canceling speaker transducers described herein include handheld controllers (e.g., gaming controllers, both two-handed and single-handed controllers, such as VR controllers), gamepads or other handheld/portable gaming devices, headphones (e.g., both single-ear and two-ear headphones), and/or similar types of electronic devices that may use an IMU(s) (e.g., for tracking, for gyro-aim, etc.) and/or speaker transducers for audio output. In an example, a game controller (or another electronic device) may include an IMU(s) and force canceling speaker transducers mounted in the housing of the game controller, and the game controller may be used to play a video game where video content is displayed on an external display, such as a television, a computer monitor, and/or the like. In this example, the force canceling speaker transducers reduce, if not eliminate, vibrations that are transferred through the device housing so that they are not exhibited in the data generated by the IMU(s). In another example, a handheld gaming device may include an IMU(s) for gyro-aim that updates the orientation of the game visuals or of a weapon in the game. To mitigate jitter in the game visuals or the aim of the weapon that would be caused by audio output, the handheld gaming device may include force canceling speaker transducers so that the game visuals and/or the gyro-aim is steady and jitter-free. In yet another example, force canceling speaker transducers can be implemented in a game controller with audio or haptics to cancel spurious motion in the tracking system that calls back to the video game so that the audio output does not adversely impact aim, user input location, and/or visual rendering on a display (e.g., a television, a computer monitor, handheld gaming device display, etc.).

Also disclosed herein are techniques and processes for mitigating vibrations in a device housing and/or for improved tracking of the device during audio output and/or stable video rendering during audio output, as well as non-transitory computer-readable media storing computer-executable instructions to implement the techniques and processes disclosed herein. Although the techniques and systems disclosed herein are often discussed, by way of example, in the context of a HMD that is used to execute video game applications, and specifically VR gaming applications, it is to be appreciated that the techniques and systems described herein may provide benefits with HMDs that are used to execute other applications, including, without limitation, non-VR applications (e.g., augmented reality (AR) applications, mixed reality (MR) applications, etc.), and/or non-gaming applications, such as industrial machine applications, defense applications, robotics applications, and the like.

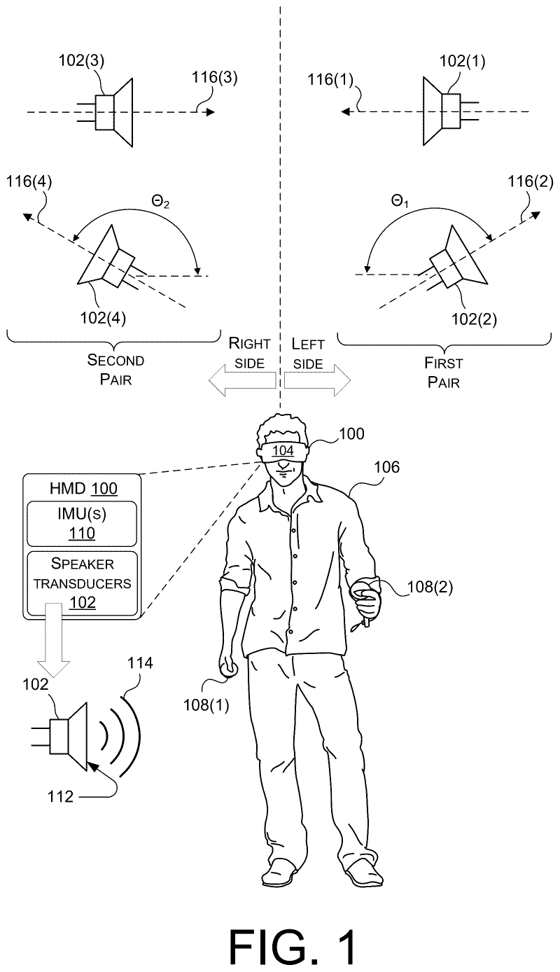

FIG. 1 illustrates an example HMD 100 that includes force canceling speaker transducers 102 mounted in a housing 104 of the HMD 100, in accordance with embodiments disclosed herein. In some examples, the HMD 100 may be a standalone HMD 100 (sometimes referred to as an “all-in-one” HMD 100) that includes all of the components described herein, and that is operable without assistance, or with minimal assistance, from a separate computer(s). In other examples, the HMD 100 is part of a distributed system that includes the HMD 100 and at least one additional computer that is separate from, yet communicatively coupled to, the HMD 100. For example, a system may include a host computer (not shown in FIG. 1) communicatively coupled to the HMD 100. In some examples, such a host computer may be collocated in the same environment as the HMD 100, such as a household of a user 106 who is wearing the HMD 100, and communicatively coupled to the HMD 100 wirelessly and/or via a wired connection. In some examples, a remote system or server(s) (not shown in FIG. 1) is communicatively coupled to a local host computer and/or to the HMD 100 via a wide-area network(s), such as the Internet. In some examples, the HMD 100 is usable with one or more handheld controllers 108 that the user 106 holds in their hand(s). FIG. 1 depicts the user 106 as holding two handheld controllers 108(1) and 108(2), such as a right controller 108(1) configured to be held in a right hand of the user 106 and a left controller 108(2) configured to be held in a left hand of the user 106.

The HMD 100 (and/or a separate computer(s) that is communicatively coupled thereto) is configured to execute an application (e.g., a video game) to render associated video content (e.g., to display a series of images) on a display panel(s) of the HMD 100 and/or to output sounds corresponding to audio content of the executing application via the speaker transducers 102 of the HMD 100. If the HMD 100 is part of a distributed system, the HMD 100 and a separate computer(s) may be configured to work together in a collaborative fashion to output such video content and/or audio content via the HMD 100. Accordingly, at least some of the components, programs, and/or data described herein, such as a processor(s), application(s) being executed, and/or the like, can reside on a separate computer(s) that is communicatively coupled to the HMD 100. Alternatively, as mentioned above, the components, programs, and/or data can reside entirely on the HMD 100, such as in a standalone HMD 100.

In some examples, the HMD 100 may represent a VR headset for use in VR systems, such as for use with a VR gaming system. However, the HMD 100 may additionally, or alternatively, be implemented as an AR headset for use in AR applications, a MR headset for use in MR applications, or a headset that is usable for VR, AR, and/or MR applications that are not game-related (e.g., industrial applications). In AR, a user 106 sees virtual objects overlaid on a real-world environment, and in MR, the user 106 may see both virtual and real-world objects that interact in real time, whereas, in VR, the user 106 does not typically see a real-world environment, but is fully immersed in a virtual environment, as perceived via the video content displayed on the display panel(s) and perceived via the optics (e.g., lenses) of the HMD 100. It is to be appreciated that, in some VR systems, pass-through imagery of the real-world environment of the user 106 may be displayed in conjunction with virtual imagery to create an augmented VR environment in a VR system, whereby the VR environment is augmented with real-world imagery (e.g., overlaid on a virtual world). Examples described herein pertain primarily to a VR-based HMD 100, but it is to be appreciated that the HMD 100 is not limited to implementation in VR applications.

FIG. 1 depicts the HMD 100 as including, without limitation, an IMU(s) 110, and the speaker transducers 102 mentioned above. It is to be appreciated, however, that the HMD 100 may include additional components not shown in FIG. 1, and, in some examples, the HMD 100 may omit the IMU(s) 110. In examples that include the IMU(s) 110, the IMU(s) 110 is mounted in the housing 104 of the HMD 100 and configured to generate data based on electrical signals received from at least one of an accelerometer(s), a gyroscope(s), a magnetometer(s), and/or other sensors. The data generated by the IMU(s) 110 can be used by the HMD 100 (and/or a separate computer(s) communicatively coupled thereto) to track the HMD 100 (e.g., to track the poses of the HMD 100) over time in 3D space. In some examples, the HMD 100 is configured to use data generated by one or more additional components, such as image data generated by a camera(s) (not shown in FIG. 1) of the HMD 100 to determine the pose of the HMD 100. In some examples the HMD 100 is configured to use a combination of different types of data, including data generated by the IMU(s) 110 and one or more additional types of data, for tracking the pose of the HMD 100. In some examples, a predicted pose of the HMD 100 is used in a rendering algorithm to render content (e.g., video content, audio content, etc.) in a manner that is consistent with the user's 106 head pose at a time when the user perceives (e.g., sees, hears, etc.) the rendered content. In an example, if the user 106 does not move their head for a period of time, the rendered video content can present imagery of a virtual environment where the virtual scene is fixed in accordance with the lack of head movement. It is to be appreciated, however, that in-motion virtual objects in the virtual scene can move in the virtual environment notwithstanding a lack of head movement. On the other hand, if the user 106 moves their head, the rendered video content can present imagery of a virtual environment where the virtual scene moves in accordance with the user's 106 head movement, as if the user 106 is turning their head in the virtual world to view a different part of the virtual world.

As shown towards the bottom of FIG. 1, each speaker transducer 102 may have a front side 112, and each speaker transducer 102 is configured to emit sound 114 during audio output. For example, a diaphragm of the speaker transducer 102 is configured to move back and forth during audio output, which causes a disturbance in the air around it, and this disturbance in the air produces corresponding sound 114 that radiates through the air. Each speaker transducer 102 is shown with an axis of motion that runs through the center of the speaker transducer 102. Both sides of the speaker transducer diaphragm produce sound that is out-of-phase with the other side. In this context the “front” side of the transducer is arbitrarily defined, and the arrow indicates the direction of positive displacement. For example, the speaker transducer 102 may include a voice coil (not shown in FIG. 1) that moves back and forth along the axis of motion, as well as a diaphragm (not shown in FIG. 1) that is attached to the voice coil and that moves in tandem with the voice coil along the axis of motion. The mass of the diaphragm, the voice coil, a voice coil former, and even air that presses against the surface area of the diaphragm is considered a moving mass in a dynamic voice coil type transducer. Although voice coil type transducers are described above, it is to be appreciated that the speaker transducers 102 can be implemented as non-voice coil type transducers, such as electrostatic transducers, magnetic planar transducers, and/or piezoelectric transducers.

Vibration is a by-product of sound generation. As mentioned above, sound 114 is generated by a diaphragm of the speaker transducer 102 moving back and forth, which moves air particles, and generates sound 114. The motion of the air particles and/or the motion of the voice coil and diaphragm, which have mass, can generate vibrations in the housing 104 of the HMD 100. As the proportion of the size and/or weight the HMD 100 that is attributable to the speaker transducers 102 increases, these vibrations could manifest as buzzing or rattling of the housing 104.

Components of the speaker transducer 102 are configured to move differently at low frequencies and high frequencies. In some examples, an individual speaker transducer 102 may be full-band (sometimes referred to herein as a “full-range,” or “wide-band”) speaker transducer 102 configured to emit sound 114 at frequencies within a range of about 20 to 20,000 Hertz (Hz). In some examples, an individual speaker transducer 102 is configured to emit sound 114 at frequencies within narrower ranges (i.e., sub-ranges within the wider 20 to 20,000 Hz range, such as a range of about 100 to 20,000 Hz), which may be the case with a mid-range speaker transducer 102, a tweeter, or other types of speaker transducers 102 (e.g., buzzers, shakers, etc.). As used herein, “low frequencies” means frequencies within a range of about 20 to 200 Hz. As used herein, “high frequencies” means frequencies within a range of about 2,000 to 20,000 Hz. Frequencies in between these low and high frequencies may be referred to herein as “mid frequencies.” Displacement of the moving components of the speaker transducer 102 is larger at low frequencies, and smaller at high frequencies. Furthermore, at high frequencies, the speaker transducer 102 is more efficient at coupling sound 114 to air. Sound 114 that is emitted from the speaker transducers 102 at high frequencies can cause interference in the data generated by the IMU(s) 110. For example, the stress and strain of these high frequencies can propagate through the housing 104 and present in the accelerometer data and/or the gyroscope data generated by the IMU(s) 110.

To achieve sound targets of bass, loudness, and frequency response shaping, in addition to preventing IMU tracking issues, the HMD 100 may include a first pair of speaker transducers 102 mounted in the housing 104 at a left side of the housing 104 for emitting sound for a left ear of the user 106, and the HMD 100 may further include a second pair of speaker transducers 102 mounted in the housing 104 at a right side of the housing 104 for emitting sound for a right ear of the user 106. The left side of the housing 104 is configured to be disposed at a left side of the head of the user 106 and the right side of the housing 104 is configured to be disposed at a right side of the head of the user 106. In this manner, the respective pairs of speaker transducers 102 are proximate to (e.g., within a threshold distance of) the respective ears of the user 106. To illustrate, the first pair of speaker transducers 102 may be mounted in the housing 104 such that they are positioned near a left cheekbone at the left side of the user's 106 face when the user 106 is wearing the HMD 100. Similarly, the second pair of speaker transducers 102 may be mounted in the housing 104 such that they are positioned near a right cheekbone at the right side of the user's 106 face when the user 106 is wearing the HMD 100. As compared to using only one speaker transducer 102 on the left side of the housing 104 and only one speaker transducer 102 on the right side of the housing 104, each speaker transducer 102 in the example of FIG. 1 can have about half the surface area of the single, larger speaker transducer to generate similar levels of audio output for the respective ear of the user 106. Although two pairs of speaker transducers 102 are depicted in FIG. 1 (e.g., a first pair and a second pair), it is to be appreciated that the HMD 100 (or any electronic device that implements the disclosed force canceling speaker transducers 102) can have any number of pairs of speaker transducers 102, including as few as one pair of speaker transducers, or more than two pairs of speaker transducers. Accordingly, the HMD 100, in some examples, can be implemented with a single pair of speaker transducers 102.

As shown in FIG. 1, the first pair of speaker transducers 102 may include a first speaker transducer 102(1) and a second speaker transducer 102(2). Meanwhile, the second pair of speaker transducers 102 may include a third speaker transducer 102(3) and a fourth speaker transducer 102(4). As shown diagrammatically in FIG. 1, the first speaker transducer 102(1) has a first axis of motion that is directed away from a front side 112 of the first speaker transducer 102(1) in a first on-axis direction 116(1), the first on-axis direction 116(1) being fixed relative to the housing 104 of the HMD 100 (because the speaker transducers 102 are rigidly mounted in the housing 104). Said another way, the front side 112 of the first speaker transducer 102(1) faces this first on-axis direction 116(1). The second speaker transducer 102(2) has a second axis of motion that is directed away from a front side 112 of the second speaker transducer 102(2) in a second on-axis direction 116(2) different than the first on-axis direction 116(1) and fixed relative to the housing 104 of the HMD 100. Said another way, the front side 112 of the second speaker transducer 102(2) faces this second on-axis direction 116(2). Because the first on-axis direction 116(1) and the second on-axis direction 116(2) are different, there is a first angle, Θ₁, between the first on-axis direction 116(1) and the second on-axis direction 116(2). Said another way, the second on-axis direction 116(2) is rotated relative to the first on-axis direction 116(1) by the first angle, Θ₁. Accordingly, the respective on-axis directions 116(1) and 116(2) (or, positive motion vectors) of the first pair of speaker transducers 102(1) and 102(2) are rotationally displaced from one another by the first angle, Θ₁. To cancel forces generated by the first pair of speaker transducers 102(1) and 102(2) during audio output from the first pair of speaker transducers 102(1) and 102(2), the first angle, Θ₁, can be within a range of about 120 to 240 degrees (e.g., Θ₁=150 degrees, Θ₁=160 degrees, Θ₁=170 degrees, Θ₁=180 degrees, etc.). In some examples, the first angle, Θ₁, can be within a range of about 145 to 155 degrees. In some examples, the first angle, Θ₁, can be within a range of about 175 to 185 degrees. It is to be appreciated that the first on-axis direction 116(1) and the second on-axis direction 116(2) can be coplanar. In some examples, the first on-axis direction 116(1) and the second on-axis direction 116(2), if coplanar, may intersect. If the second on-axis direction 116(2) is rotationally displaced from the first on-axis direction 116(1) by a first angle, Θ₁, of 180 degrees, the on-axis directions 116(1) and 116(2) can be parallel or colinear. In some examples, the first on-axis direction 116(1) and the second on-axis direction 116(2) can be skew lines in 3D space. Nevertheless, even in a case of skew lines, the first angle, Θ₁, may represent an angle between the first on-axis direction 116(1) and a line that is parallel to the second on-axis direction 116(2) and on the same plane as the first on-axis direction 116(1).

Similarly, as shown diagrammatically in FIG. 1, the third speaker transducer 102(3) has a third axis of motion that is directed away from a front side 112 of the third speaker transducer 102(3) in a third on-axis direction 116(3), the third on-axis direction 116(3) being fixed relative to the housing 104 of the HMD 100. Said another way, the front side 112 of the third speaker transducer 102(3) faces this third on-axis direction 116(3). The fourth speaker transducer 102(4) has a fourth axis of motion that is directed away from a front side 112 of the fourth speaker transducer 102(4) in a fourth on-axis direction 116(4) different than the third on-axis direction 116(3) and fixed relative to the housing 104 of the HMD 100. Said another way, the front side 112 of the fourth speaker transducer 102(4) faces this fourth on-axis direction 116(4). Because the third on-axis direction 116(3) and the fourth on-axis direction 116(4) are different, there is a second angle, Θ₂, between the third on-axis direction 116(3) and the fourth on-axis direction 116(4). Said another way, the fourth on-axis direction 116(4) is rotated relative to the third on-axis direction 116(3) by the second angle, Θ₂. Accordingly, the respective on-axis directions 116(3) and 116(4) (or, positive motion vectors) of the second pair of speaker transducers 102(3) and 102(4) are rotationally displaced from one another by the second angle, Θ₂. To cancel forces generated by the second pair of speaker transducers 102(3) and 102(4) during audio output from the second pair of speaker transducers 102(3) and 102(4), the second angle, Θ₂, can be within a range of about 120 to 240 degrees (e.g., Θ₂=150 degrees, Θ₂=160 degrees, Θ₂=170 degrees, Θ₂=180 degrees, etc.). In some examples, the second angle, Θ₂, can be within a range of about 145 to 155 degrees. In some examples, the second angle, Θ₂, can be within a range of about 175 to 185 degrees. It is to be appreciated that the third on-axis direction 116(3) and the fourth on-axis direction 116(4) can be coplanar. In some examples, the third on-axis direction 116(3) and the fourth on-axis direction 116(4), if coplanar, may intersect. If the fourth on-axis direction 116(4) is rotationally displaced from the third on-axis direction 116(3) by a second angle, Θ₂, of 180 degrees, the on-axis directions 116(3) and 116(4) can be parallel or colinear. In some examples, the third on-axis direction 116(3) and the fourth on-axis direction 116(4) can be skew lines in 3D space. Nevertheless, even in a case of skew lines, the second angle, Θ₂, may represent an angle between the third on-axis direction 116(3) and a line that is parallel to the fourth on-axis direction 116(4) and on the same plane as the third on-axis direction 116(3).

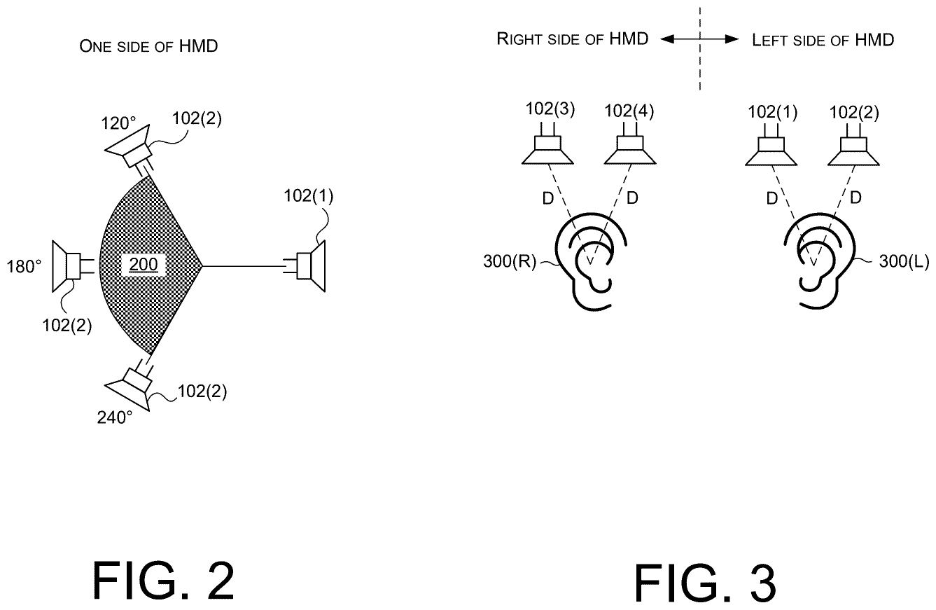

FIG. 2 is a diagram illustrating a range 200 of angles by which a pair of speaker transducers 102(1) and 102(2) can be rotationally displaced from one another for canceling forces generated by the individual speaker transducers 102 during audio output, in accordance with embodiments disclosed herein. Although FIG. 2 illustrates the first pair of speaker transducers 102(1) and 102(2) of FIG. 1, which are mounted in the housing 104 of the HMD 100 at the left side of the housing 104, it is to be appreciated that the range 200 shown in FIG. 2 is equally applicable to the second pair of speaker transducers 102(3) and 102(4) of FIG. 1, which are mounted in the housing 104 of the HMD 100 at the right side of the housing 104. As shown in FIG. 2, the second speaker transducer 102(2) can face a second on-axis direction 116(2) that is rotated relative to a first on-axis direction 116(1) in which the first speaker transducer 102(1) is facing by an angle of 120 degrees, an angle of 240 degrees, or any angle therebetween in order to cancel forces generated by the first pair of speaker transducers 102(1) and 102(2) during audio output from the first pair of speaker transducers 102(1) and 102(2). This rotational (or angular displacement) between the first speaker transducer 102(1) and the second speaker transducer 102(2) mitigates vibrations that would otherwise be transferred through the housing 104 of the HMD 100 during audio output, thereby preventing IMU(s) 110 tracking errors and allowing for rendering jitter-free (i.e., stable and smooth) video content. The range 200 of angles illustrated in FIG. 2 can provide flexibility to achieve acoustic targets of the HMD 100, as well as size and shape targets of the HMD 100 to accommodate various designs for the HMD 100 while maintaining high quality audio output.

In an idealized solution, if amplitude, A, is the amplitude of a single, larger speaker transducer that could be mounted at the left or the right side of the housing 104 and configured to achieve acoustic targets for the HMD 100, then each speaker transducer 102 disclosed herein has an amplitude, A/2, to achieve similar acoustic targets for the HMD 100. If the first speaker transducer 102(1) and the second speaker transducer 102(2), for example, have on-axis directions 116(1) and 116(2) that are aligned (e.g., if the first angle, Θ₁, is 0 degrees), forces generated by the first pair of speaker transducers 102(1) and 102(2) would not be canceled. If the first pair of speaker transducers 102(1) and 102(2) have on-axis directions 116(1) and 116(2) facing opposite directions (e.g., if the first angle, Θ₁, is 180 degrees), near perfect cancelation of forces may be achieved (e.g., negative infinity decibels (dB)). If the second on-axis direction 116(2) of the second speaker transducer 102(2) is rotated relative to the first on-axis direction 116(1) of the first speaker transducer 102(1) by a first angle, Θ₁, of 120 degrees, the idealized overall output would be reduced by 12 dB. The reduction in output, in a theoretical sense, is shown in Equation (1), below:

Output Reduction [dB]=20*log₁₀(A/2+A/2*cos θ) (1)

An example design goal of the audio subsystem of the HMD 100 is to reduce the audio influence of the speaker transducers 102 on the rendering output that uses the tracking system (including the IMU(s) 110). While perfect force cancelation may be desired in some implementations, the amount of force cancelation that results in perceptually good tracking and rendering is not as strict, and good performance can be achieved with less than perfect cancelation of forces. The range 200 from 120 to 240 degrees, as shown in FIG. 2, allows overall optimization of the HMD 100 across industrial design, audio, and tracking goals, resulting in an overall very good experience for a user 106 of the HMD 100.

In some examples, a radiating portion of the first speaker transducer 102(1) may be in phase with a radiating portion of the second speaker transducer 102(2) to ensure the sound 114 reaching the left ear of the user 106 is the same as, or similar to, the sound from a single speaker transducer, if the single speaker transducer was mounted in the housing 104 at the left side of the housing 104 instead of the first pair of speaker transducers 102(1) and 102(2). In some examples, beamforming can be used to direct sound 114 from the speaker transducers 102(1) and 102(2) towards the left ear of the user 106. Similarly, in some examples, a radiating portion of the third speaker transducer 102(3) may be in phase with a radiating portion of the fourth speaker transducer 102(4) to ensure the sound 114 reaching the right ear of the user 106 is the same as, or similar to, the sound from a single speaker transducer, if the single speaker transducer was mounted in the housing 104 at the right side of the housing 104 instead of the second pair of speaker transducers 102(3) and 102(4). In some examples, beamforming can be used to direct sound 114 from the speaker transducers 102(3) and 102(4) towards the right ear of the user 106. These techniques can improve sound quality and/or prevent the inadvertent creation of comb-filtering or a dipole that causes sound cancelation with the first pair of speaker transducers 102(1) and 102(2) and/or the second pair of speaker transducers 102(3) and 102(4). In other words, the orientation of each pair of speaker transducers 102 with respect to the corresponding ear of the user 106 is to be considered carefully to prevent unwanted frequency response cancelations due to arbitrary mounting of the speaker transducers 102.

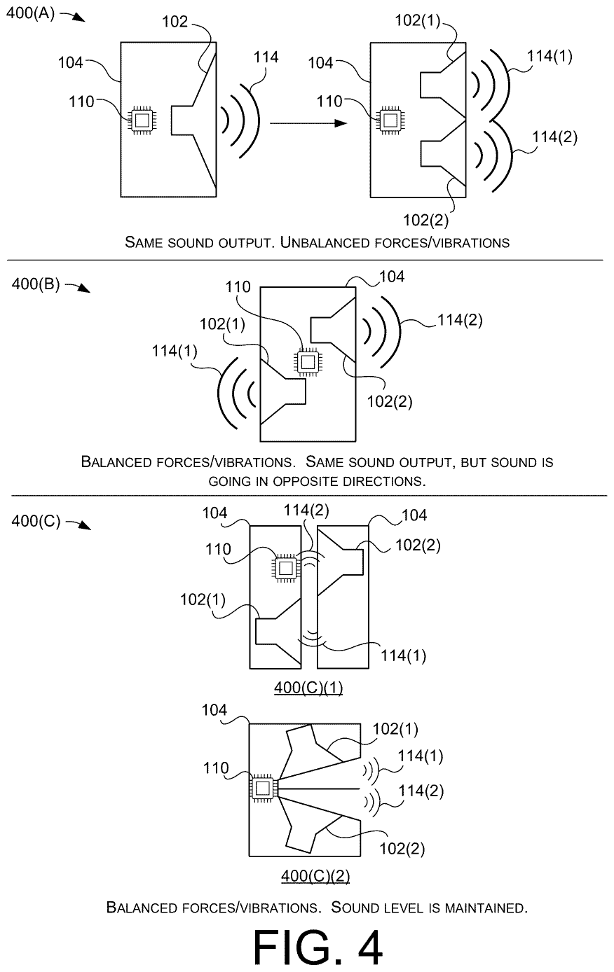

FIG. 3 is a diagram illustrating that a first pair of speaker transducers 102(1) and 102(2) are positioned in the HMD 100 to be substantially equidistant from a left ear 300(L) of a user 106 of the HMD 100, when the HMD 100 is worn on the user's head. For example, the first speaker transducer 102(1) and the second speaker transducer 102(2) may be mounted in the HMD 100 such that the first speaker transducer 102(1) is spaced a distance, D, from the left ear 300(L) when the user 106 is wearing the HMD 100, and such that the second speaker transducer 102(2) is also spaced the distance, D, from the left ear 300(L) when the user 106 is wearing the HMD 100. FIG. 3 further illustrates that a second pair of speaker transducers 102(3) and 102(4) are positioned in the HMD 100 to be substantially equidistant from a right ear 300(R) of the user 106 of the HMD 100, when the HMD 100 is worn on the user's head. For example, the third speaker transducer 102(3) and the fourth speaker transducer 102(4) may be mounted in the HMD 100 such that the third speaker transducer 102(3) is spaced a distance, D, from the right ear 300(R) when the user 106 is wearing the HMD 100, and such that the fourth speaker transducer 102(4) is also spaced the distance, D, from the right ear 300(R) when the user 106 is wearing the HMD 100.

The positioning of the speaker transducers 102 relative to the ears 300 of the user 106, as depicted diagrammatically in FIG. 3, prevents comb-filtering between the respective pairs of speaker transducers 102. That is, for speaker transducers 102 that are configured to emit sound 114 at high frequencies, the distance, D, between each speaker transducer 102 (of a pair of speaker transducers 102) and the corresponding ear 300 of the user 106 is to be similar enough to prevent comb-filtering due to different path lengths between the respective speaker transducers 102 (of a pair of speaker transducers 102) and the ear 300, which can cause poor audio quality. If the user's left ear 300(L) is equidistant from the first pair of transducers 102(1) and 102(2), then the sound 114 emitted from the speaker transducers 102(1) and 102(2) will sum nicely for a substantially flat frequency response. By contrast, if the left ear 300(L) is positioned off axis with respect to the first pair of speaker transducers 102(1) and 102(2), there can be a path length difference that causes comb-filtering. The same holds true for the right ear 300(R) and the second pair of speaker transducers 102(3) and 102(4). In some examples, a signal processing algorithm may be used in lieu of, or in addition to, the positioning depicted in FIG. 3 to compensate for different path lengths of a pair of speaker transducers 102, thereby mitigating comb-filtering. Audio signal processing for comb-filtering may include delay, all-pass filtering, phase shifting, and/or band-limited frequency shaping for one or both speaker transducers 102 to prevent poor audio, including comb-filtering, at the listening position. Audio signal processing for mitigation of comb-filtering can be used to in combination with the vibration mitigation configurations (e.g., the force canceling speaker transducers 102 described herein) to maximize sound quality.

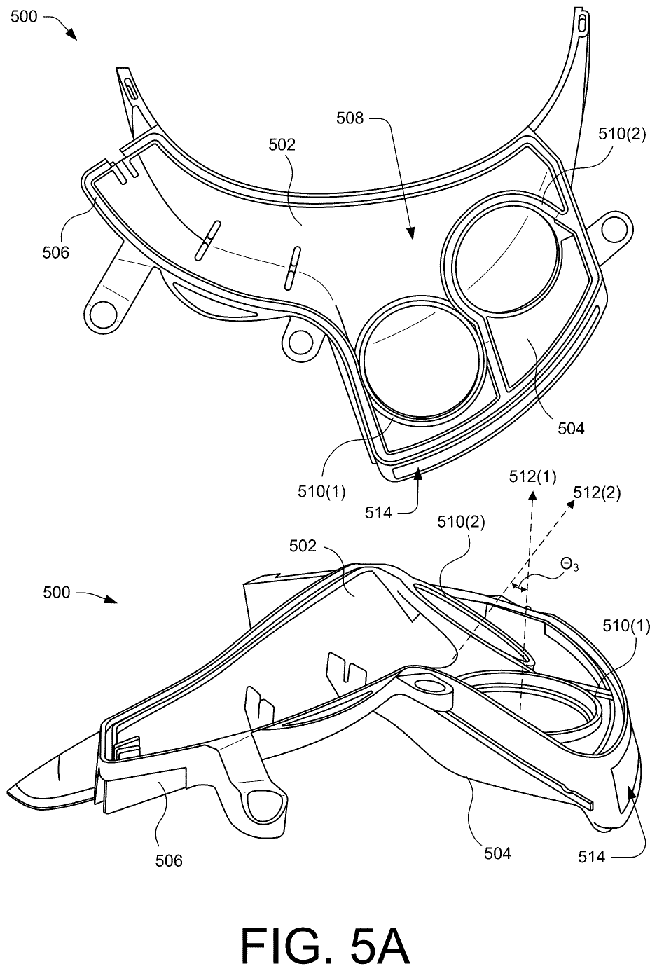

FIG. 4 illustrates diagrams of different implementations of speaker transducers, and the effects of those implementations on sound output and force/vibration balancing, in accordance with embodiments disclosed herein. In the first diagram 400(A), a single speaker transducer 102 with surface area, S_{d}, and with an excursion, Xₘₐₓ, generates a volumetric displacement, V_{d}. V_{d} is the total potential sound output of the single speaker transducer 102. Also, in the first diagram 400(A), and in contrast to the single speaker transducer 102 on the left side of the first diagram 400(A), a pair of speaker transducers, including a first speaker transducer 102(1) and a second speaker transducer 102(2), each with surface area, S_{d}/2, and with an excursion, Xₘₐₓ, are shown on the right side of the first diagram 400(A). The pair of speaker transducers 102(1), 102(2) is configured to generate the same total sound output as the total sound output from the single speaker transducer 102. It is to be appreciated that there are many combinations, some with less surface area, S_{d}, and with more excursion, Xₘₐₓ, and others with more surface area, S_{d}, and with less excursion, Xₘₐₓ, but the end result is that the same total sound output can be generated by the pair of speaker transducers 102(1), 102(2), as compared to the sound output from the single speaker transducer 102. However, in the implementation shown in the first diagram 400(A), the sound 114 from each speaker transducer 102(1) and 102(2) is traveling in the same direction (e.g., the first sound 114(1) emitted by the first speaker transducer 102(1) travels in the same direction as the second sound 114(2) emitted by the second speaker transducer 102(2)). This is because the respective on-axis directions of the speaker transducers 102(1) and 102(2) is the same, which results in the forces and/or vibrations caused by the sound output to be unbalanced. This unbalanced nature of the forces and/or vibrations due to audio output can lead to interference with a system's ability to accurately track a device that is to be tracked (e.g., the HMD 100) and/or interference with the system's ability to render video content (e.g., images) in a smooth, stable manner via a display (e.g., the display panel(s) of the HMD 100), as described in detail above.

In the second diagram 400(B), for similar reasons to those described above with respect to the first diagram 400(A), the pair of speaker transducers 102(1), 102(2) is configured to generate the same total sound output as the single speaker transducer 102 shown on the left side of the first diagram 400(A). However, since the pair of speaker transducers 102(1) and 102(2) in the second diagram 400(B) have on-axis directions 116(1) and 116(2) facing opposite directions, the sound 114 from each speaker transducer 102(1) and 102(2) travels in substantially opposite directions (e.g., the first sound 114(1) emitted by the first speaker transducer 102(1) travels in the opposite direction as the second sound 114(2) emitted by the second speaker transducer 102(2)). The result of the implementation depicted in the second diagram 400(B) is that forces and/or vibrations caused by the sound output are balanced. However, with respect to the sound output, the implementation depicted in the second diagram 400(B) can sometimes sound the same as the sound 114 emitted by the single speaker transducer 102 shown on the left side of the first diagram 400(A), depending on where the listener (e.g., the user 106, and more specifically the user's ear 300) is located relative to the pair of speaker transducers 102(1), 102(2), and also depending on the frequency of the sound being output (e.g., the implementation shown in the second diagram 400(B) may not sound the same as the single speaker transducer 102 shown on the left side of the first diagram 400(A) for sound that is output at high frequencies (e.g., frequencies within a range of about 2,000 to 20,000 Hz)).

In the third diagram 400(C), for similar reasons to those described above with respect to the first diagram 400(A), the pair of speaker transducers 102(1), 102(2) shown in the third diagram 400(C) is configured to generate the same total sound output as the sound output from the single speaker transducer 102 shown on the left side of the first diagram 400(A). In addition, the pair of speaker transducers 102(1) and 102(2) shown in the third diagram 400(C) have on-axis directions 116(1) and 116(2) facing different directions, which results in the forces and/or vibrations caused by the sound output to be balanced. For example, in the sub-diagram 400(C)(1), the pair of speaker transducers 102(1) and 102(2) have on-axis directions 116(1) and 116(2) facing opposite directions. Meanwhile, in the sub-diagram 400(C)(2), the pair of speaker transducers 102(1) and 102(2) have on-axis directions 116(1) and 116(2) facing different directions that are not opposite (e.g., with an angle between the respective on-axis directions 116(1), 116(2) being within a range of about 120 to 240 degrees (e.g., an angle of about 150 degrees)). The relative positions of the speaker transducers 102(1), 102(2) within the housing 104 of the device (e.g., the HMD 100) also effects the sound output. That is, in the implementation shown in the third diagram 400(C), the sound level is maintained in the sense that the sound 114(1), 114(2) output from the pair of speaker transducers 102(1), 102(2) sounds the same as the sound 114 output from the single speaker transducer 102 shown on the left side of the first diagram 400(A).

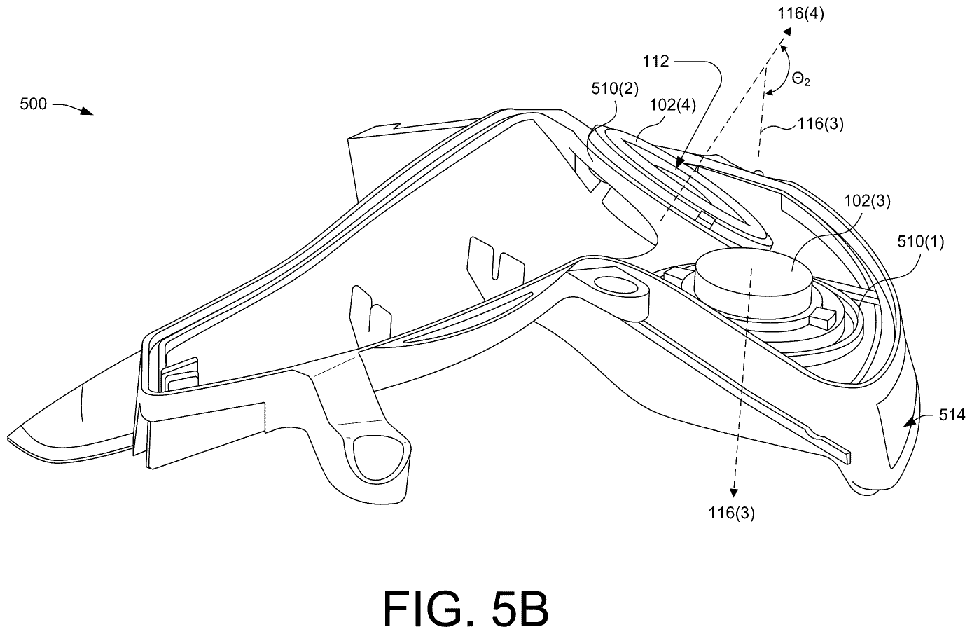

FIG. 5A illustrates a top view and a side view of an example baffle 500 of the housing 104 of the HMD 100 in which a pair of speaker transducers 102(3) and 102(4) are configured to be mounted, in accordance with embodiments disclosed herein. For illustrative purposes, the baffle 500 (e.g., a second baffle 500(2)) shown in FIG. 5A represents a portion of the housing 104 at the right side of the housing 104. It is to be appreciated that, another baffle (e.g., a first baffle 500(1)) at the left side of the housing 104 can have a similar configuration to that of the baffle 500 (e.g., the second baffle 500(2)) described in detail below with reference to FIGS. 5A-5B. As shown in FIG. 5A, the baffle 500 is molded to have a contoured body with a convex portion 502 that transitions to a concave portion 504. The convex portion 502 and the concave portion 504 of the baffle 500, in combination with a side wall 506 that runs along a periphery of the baffle 500, create a cavity 508, which provides air volume for sound 114 emitted from the speaker transducers 102 to radiate out of the housing 104 and towards the right ear 300(R) of the user 106. A pair of ring-shaped receptacles 510(1) and 510(2) are suspended in the cavity 508 of the baffle 500. For example, the ring-shaped receptacles 510(1) and 510(2) may be connected to, and project from, the side wall 506 such that the ring-shaped receptacles 510(1) and 510(2) are suspended within the cavity 508 (e.g., spaced a distance from the convex portion 502 and the concave portion 504 of the baffle 500. As shown in FIG. 5A, the ring-shaped receptacles 510(1) and 510(2) are adjacent one another. For example, the ring-shaped receptacles 510(1) and 510(2) may be touching each other, or the ring-shaped receptacles 510(1) and 510(2) may be connected by a small piece of material interposed between the ring-shaped receptacles 510(1) and 510(2).

Each ring-shaped receptacle 510 is configured to receive a respective speaker transducer 102. In some examples, a diameter of each ring-shaped receptacle 510 is about 15 millimeters (mm), but other sizes (e.g., 16 mm, 16.2 mm, etc.) may be implemented to accommodate mounting speaker transducers 102 of smaller or larger sizes for electronic devices of various form factors. Each ring-shaped receptacle 510 has an axis 512 running through its center. When the speaker transducer 102 is mounted in the housing 104 within its designated ring-shaped receptacle 510, the axis 512 of the ring-shaped receptacle 510 and the axis of motion of the speaker transducer 102 are colinear. As shown in the side view of the baffle 500 depicted in FIG. 5A, the first ring-shaped receptacle 510(1) has a first axis 512(1) running through its center, and the second ring-shaped receptacle 510(2) has a second axis 512(2) running through its center.

As further illustrated in FIG. 5A, the orientations of the ring-shaped receptacles 510(1) and 510(2) are different. Accordingly, there is an angle, Θ₃, between the first axis 512(1) of the first ring-shaped receptacle 510(1) and the second axis 512(2) of the second ring-shaped receptacle 510(2). Said another way, the first axis 512(1) of the first ring-shaped receptacle 510(1) is rotated relative to the second axis 512(2) of the second ring-shaped receptacle 510(2) by an angle, Θ₃. In the example of FIG. 5A, the angle, Θ₃, is about 30 degrees, although the angle, Θ₃, can vary. For example, the angle, Θ₃, can be chosen to orient the speaker transducers 102(3) and 102(4) such that the second angle, Θ₂, (described above as being between the third on-axis direction 116(3) and the fourth on-axis direction 116(4)) is within a range of about 120 to 240 degrees in order to mitigate vibrations that would otherwise be transferred through the housing 104 of the HMD 100 during audio output from the speaker transducers 102(3) and 102(4). It is to be appreciated that, in an example where the first axis 512(1) and the second axis 512(2) are skew lines in 3D space, the angle, Θ₃, may represent an angle between the first axis 512(1) of the first ring-shaped receptacle 510(1) and a line that is parallel to the second axis 512(2) of the second ring-shaped receptacle 510(2) and on the same plane as the first axis 512(1).

FIG. 5B illustrates a side view of the baffle 500 of FIG. 5A with a pair of speaker transducers 102(3) and 102(4) mounted to the baffle 500, in accordance with embodiments disclosed herein. As shown in FIG. 5B, the third speaker transducer 102(3), which has a cylindrical shape, is mounted to the baffle 500 by inserting the third speaker transducer 102(3) into the first ring-shaped receptacle 510(1) with the front side 112 (see FIG. 1) of the third speaker transducer 102(3) facing the baffle 500. In other words, the third speaker transducer 102(3) is mounted in the housing 104 of the HMD 100 by inserting the third speaker transducer 102(3) into the first ring-shaped receptacle 510(1) of the baffle 500 front side 112 first. The fourth speaker transducer 102(4), which has a cylindrical shape, is mounted to the baffle 500 by inserting the fourth speaker transducer 102(4) into the second ring-shaped receptacle 510(2) with the front side 112 of the fourth speaker transducer 102(4) facing away from the baffle 500. In other words, the fourth speaker transducer 102(4) is mounted in the housing 104 of the HMD 100 by inserting the fourth speaker transducer 102(4) into the second ring-shaped receptacle 510(2) of the baffle 500 back side first (or, front side 112 last). In this manner, the third speaker transducer 102(3) is facing the baffle 500 when the third speaker transducer 102(3) is mounted in the housing 104 of the HMD 100, and the fourth speaker transducer 102(4) is facing away from the baffle 500 when the fourth speaker transducer 102(4) is mounted in the housing 104 of the HMD 100. Although, in some examples, this could mean that the second angle, Θ₂, between the third on-axis direction 116(3) of the third speaker transducer 102(3) and the fourth on-axis direction 116(4) of the fourth speaker transducer 102(4) is 180 degrees, the second angle, Θ₂, does not have to be 180 degrees for adequate force cancelation. In fact, in the example of FIG. 5B, the second angle, Θ₂, is about 150 degrees, due to the angle, Θ₃, between the first axis 512(1) of the first ring-shaped receptacle 510(1) and the second axis 512(2) of the second ring-shaped receptacle 510(2) being about 30 degrees in the example baffle 500 depicted in FIGS. 5A-5B.

Accordingly, when the speaker transducers 102(3) and 102(4) are mounted in the housing 104 of the HMD 100, as shown by way of example in FIG. 5B, a front side 112 of the third speaker transducer 102(3) is facing in the third on-axis direction 116(3) that is fixed relative to the housing 104. Said another way, the third speaker transducer 102(3) has a third axis of motion that is directed away from the front side 112 of the third speaker transducer 102(3) in the third on-axis direction 116(3). The fourth speaker transducer 102(4) is mounted in the housing 104 such that a front side 112 of the fourth speaker transducer 102(2) is facing in the fourth on-axis direction 116(4) that is also fixed relative to the housing 104, but different than the third on-axis direction 116(3). Said another way, the fourth speaker transducer 102(4) has a fourth axis of motion that is directed away from the front side 112 of the fourth speaker transducer 102(4) in the fourth on-axis direction 116(4), which is different than the third on-axis direction 116(3). In the example of FIG. 5B, the second angle, Θ₂, between the third on-axis direction 116(3) and the fourth on-axis direction 116(4) is about 150 degrees, which is within the range 200 (e.g., a range of 120 to 240 degrees). Said another way, the fourth on-axis direction 116(4), in the example of FIG. 5B, is rotated relative to the third on-axis direction 116(3) by a second angle, Θ₂, of about 150 degrees. It is to be appreciated, however, that, in order to achieve audio output targets and remove perceptible jitter from rendered video content, as described above, the second angle, Θ₂, can vary anywhere within a range of about 120 to 240 degrees for cancelation of forces generated by the second pair of speaker transducers 102(3) and 102(4) during audio output therefrom.

Although a detailed example of the housing 104 of the HMD 100 fully assembled is not shown (other than diagrammatically in FIG. 1), it is to be appreciated that the housing 104 may have defined therein respective radiating sound exits at the left side of the housing 104 and the right side of the housing 104. FIGS. 5A and 5B depict an example of a sound exit 514 (e.g., a second sound exit 514(2)) at the right side of the housing 104. These sound exits 514 are configured to face the left ear 300(L) and the right ear 300(R) of the user 106 of the HMD 100, respectively. For example, the first pair of speaker transducers 102(1) and 102(2) are configured to emit sound 114 for the left ear 300(L) through a first sound exit 514(1) defined in the housing 104, and the second pair of speaker transducers 102(3) and 102(4) are configured to emit sound 114 for the right ear 300(R) through the sound exit 514 (e.g., a second sound exit 514(2)) defined in the housing 104. As shown in FIGS. 5A and 5B for the baffle 500, these sound exits 514 may be defined in the respective baffles 500(1) and 500(2) of the housing 104. In some examples, respective waveguides are defined in the housing 104 to direct the sound 114 emitted for the left ear 300(L) through the first sound exit and to direct sound 114 emitted for the right ear 300(R) through the second sound exit 514 with minimal energy loss. Accordingly, the aforementioned sound exits that are defined in the housing 104 of the HMD 100 may represent openings of the respective waveguides.

In some examples, when the HMD 100 is fully assembled, there are cavities in the housing 104 in front of each speaker transducer 102. The cavities should not be too large, otherwise an undesired resonance can be created within the cavities during audio output. The exact size of the cavities depends on the implementation. In some examples, a pair of speaker transducers 102 on one side of the HMD 100 (e.g., the second pair of speaker transducers 102(3) and 102(4) at the right side of the housing 104 of the HMD 100) are configured to emit sound into respective air chambers that have substantially the same volume.

It is to be appreciated that the example implementation of the baffle 500 shown in FIG. 5B is beneficial from a standpoint of manufacturability, industrial design, and/or other factors. Accordingly, force canceling speaker transducers 102 for other types of electronic devices having different form factors and/or different applications of use may be implemented differently. For example, an electronic device with less space and/or volume constraints that the example HMD 100 may implement force canceling speaker transducers 102 with respective front sides facing respective on-axis directions 116 that are angularly displaced by an angle of 180 degrees for near perfect cancelation of forces.

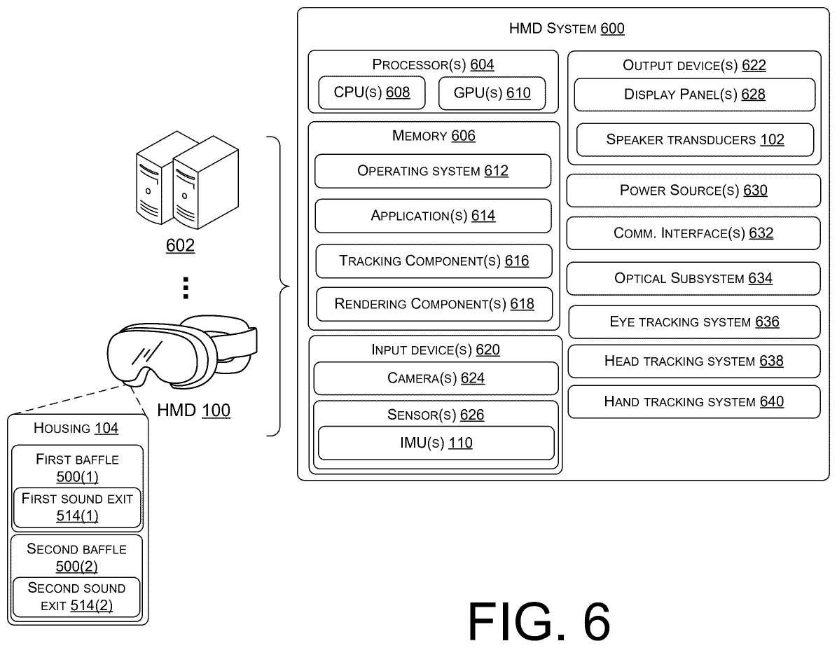

FIG. 6 illustrates example components of a HMD system 600 in which the techniques disclosed herein can be implemented, in accordance with embodiments disclosed herein. As mentioned above, the HMD 100 can be part of a distributed system including the HMD 100 and one or more additional computers 602 that is/are communicatively coupled to the HMD 100. In FIG. 6, the additional computer(s) 602 may represent a host computer collocated in the same environment as the HMD 100 during use of the HMD 100 and/or a remote system that is located at a geographically remote location with respect to the HMD 100 and communicatively coupled to the HMD 100 over a wide-area network (e.g., the Internet). Alternatively, the HMD system 600 can represent a standalone HMD 100.

The HMD 100 may be implemented as a device that is to be worn by a user 106 (e.g., on a head of the user 106). In some embodiments, the HMD 100 may be head-mountable, such as by allowing a user 106 to secure the HMD 100 on his/her head using a securing mechanism (e.g., an adjustable band) that is sized to fit around a head of a user 106. In some embodiments, the HMD 100 is a VR, AR, or MR headset that includes a near-eye or near-to-eye display(s). As such, the terms “wearable device”, “wearable electronic device”, “VR headset”, “AR headset”, “MR headset”, and “head-mounted display (HMD)” may be used interchangeably herein to refer to the HMD 100. However, it is to be appreciated that these types of devices are merely examples of a HMD 100, and it is to be appreciated that the HMD 100 may be implemented in a variety of other form factors.

In the illustrated implementation, the HMD system 600 includes one or more processors 604 and memory 606 (e.g., computer-readable media 606). In some implementations, the processors(s) 604 may include a central processing unit(s) (CPU(s)) 608, a graphics processing unit(s) (GPU(s)) 610, both a CPU(s) 608 and a GPU(s) 610, a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 604 may possess its own local memory, which also may store program modules, program data, and/or one or more operating systems.

The memory 606 may include volatile and nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, redundant array of independent disks (RAID) storage systems, or any other medium which can be used to store the desired information and which can be accessed by a computing device. The memory 606 may be implemented as computer-readable storage media (“CRSM”), which may be any available physical media accessible by the processor(s) 604 to execute instructions stored on the memory 606. In one basic implementation, CRSM may include RAM and Flash memory. In other implementations, CRSM may include, but is not limited to, ROM, EEPROM, or any other non-transitory and/or tangible medium which can be used to store the desired information, and which can be accessed by the processor(s) 604.

In general, the HMD system 600 may include logic (e.g., software, hardware, and/or firmware, etc.) that is configured to implement the techniques, functionality, and/or operations described herein. The computer-readable media 606 is shown as including various modules, such as instruction, datastores, and so forth, which may be configured to execute on the processor(s) 604 for carrying out the techniques, functionality, and/or operations described herein. A few example functional modules are shown as stored in the computer-readable media 606 and executable on the processor(s) 604, although the same functionality may alternatively be implemented in hardware, firmware, or as a system on a chip (SOC), and/or other logic.

An operating system module 612 may be configured to manage hardware within and coupled to the HMD 100 and/or the HMD system 600 for the benefit of other modules. In addition, in some instances the HMD system 600 may include one or more applications 614 stored in the memory 606 or otherwise accessible to the HMD system 600. In this implementation, the application(s) 614 includes a gaming application (e.g., a video game application). However, the HMD system 600 may include any number or type of applications and is not limited to the specific example shown here. A tracking component(s) 616 may be configured to perform tracking operations described herein, such as eye tracking, head tracking, and/or hand tracking. Head tracking (e.g., tracking the poses of the HMD 100 over time) was briefly described above, and is described in more detail below, as is eye tracking and hand tracking. A rendering component(s) 618 (e.g., a compositor) may be configured to render content (e.g., video content, audio content, etc.) via the HMD 100 in a manner that is consistent with the pose of the HMD 100 at a time when the user 106 perceives the rendered content.

Generally, the HMD system 600 has input devices 620 and output devices 622. The input devices 620 may include control buttons. In some implementations, one or more microphones may function as input devices 620 to receive audio input, such as user voice input. As shown in the example of FIG. 6, in some implementations, one or more cameras 624 or other types of sensors 626, such as the IMU 110, may function as input devices 620. For example, the IMU 110 may be configured to detect head motion of the user 106, including for gestural input purposes. The sensors 626 (e.g., the IMU(s) 110) may further include sensors used to generate motion, position, and/or orientation data, such as gyroscopes, accelerometers, magnetometers, color sensors, or other motion, position, and orientation sensors. The sensors 626 may also include sub-portions of sensors, such as a series of active or passive markers that may be viewed externally by a camera or color sensor in order to generate motion, position, and orientation data. For example, a VR headset may include, on its exterior, multiple markers, such as reflectors or lights (e.g., infrared or visible light) that, when viewed by an external camera or illuminated by a light (e.g., infrared or visible light), may provide one or more points of reference for interpretation by software in order to generate motion, position, and orientation data. The sensors 626 may include light sensors that are sensitive to light (e.g., infrared or visible light) that is projected or broadcast by base stations in the environment of the HMD 100. IMU 110 may be an electronic device that generates data based on electrical signals received from accelerometers, gyroscopes, magnetometers, and/or other sensors suitable for detecting motion, correcting error associated with IMU 110, or some combination thereof. Based on the measurement signals such motion-based sensors, such as the IMU 110, may generate data indicating an estimated position, orientation, and/or pose of HMD 100 relative to an initial position, orientation, and/or pose of HMD 100. For example, multiple accelerometers may measure translational motion (forward/back, up/down, left/right) and multiple gyroscopes may measure rotational motion (e.g., pitch, yaw, and roll). IMU 110 can, for example, rapidly sample the measurement signals and calculate the estimated position, orientation, and/or pose of HMD 100 from the sampled data. For example, IMU 110 may integrate measurement signals received from the accelerometers over time to estimate a velocity vector and integrates the velocity vector over time to determine an estimated position of a reference point on HMD 100. The reference point is a point that may be used to describe the position of the HMD 100. While the reference point may generally be defined as a point in space, in various embodiments, reference point is defined as a point within the HMD 100 (e.g., a center of the IMU 110). Alternatively, IMU 110 provides the sampled measurement signals to an external console (or other computing device), which determines the data.

The sensors 626 may operate at relatively high frequencies in order to provide sensor data at a high rate. For example, sensor data may be generated at a rate of 1000 Hz (or 1 sensor reading every 1 millisecond). In this way, one thousand readings are taken per second. When sensors generate this much data at this rate (or at a greater rate), the data set used for predicting motion is quite large, even over relatively short time periods on the order of the tens of milliseconds. As mentioned, in some embodiments, the sensors 626 may include light sensors that are sensitive to light emitted by base stations in the environment of the HMD 100 for purposes of tracking position and/or pose, etc., of the HMD 100 in 3D space. The calculation of position and/or pose may be based on timing characteristics of light pulses and the presence or absence of light detected by the sensors 626.

In some embodiments, additional input devices 620 may be provided in the form of a keyboard, keypad, mouse, touch screen, joystick, and the like. In other embodiments, the HMD system 600 may omit a keyboard, keypad, or other similar forms of mechanical input. In some examples, the input device(s) 620 may include control mechanisms, such as basic volume control button(s) for increasing/decreasing volume, as well as power and reset buttons.

The output devices 622 may include a display(s) or display panels 628, (e.g., a stereo pair of display panels). The display panel(s) 628 of the HMD system 600 may utilize any suitable type of display technology, such as an emissive display that utilizes light emitting elements (e.g., light emitting diodes (LEDs)) to emit light during presentation of frames on the display panel(s) 628. As an example, display panel(s) 628 of the HMD system 600 may include liquid crystal displays (LCDs), organic light emitting diode (OLED) displays, inorganic light emitting diode (ILED) displays, or any other suitable type of display technology for HMD applications. The output devices 622 may further include, without limitation, a light element (e.g., LED), a vibrator to create haptic sensations, as well as the aforementioned speaker transducers 102. In some examples, the speaker transducers 102 are embedded/mounted in or on the housing 104 of the HMD 100.

The HMD system 600 (e.g., the HMD 100) may include a power source(s) 630, such as one or more batteries. Additionally, or alternatively, the HMD 100 may include a power cable port to connect to an external power source via wired means, such as a cable.

The HMD system 600 (e.g., the HMD 100) may further include a communications interface(s) 632, such as a wireless unit coupled to an antenna(s) to facilitate a wireless connection to a network. Such a wireless unit may implement one or more of various wireless technologies, such as Wi-Fi, Bluetooth, radio frequency (RF), and so on. It is to be appreciated that the HMD 100 may further include physical ports to facilitate a wired connection to a network, a connected peripheral device (including the compute(s) 602, such as a host computer, which may be a PC, a game console, etc.), or a plug-in network device that communicates with other wireless networks.

The HMD 100 may further include optical subsystem 634 that directs light from the electronic display panel(s) 628 to a user's eye(s) using one or more optical elements. The optical subsystem 634 may include various types and combinations of different optical elements, including, without limitation, apertures, lenses (e.g., Fresnel lenses, convex lenses, concave lenses, etc.), filters, and so forth. In some embodiments, one or more optical elements in optical subsystem 634 may have one or more coatings, such as anti-reflective coatings. Magnification of the image light by optical subsystem 634 allows electronic display panel(s) 628 to be physically smaller, weigh less, and consume less power than larger displays. Additionally, magnification of the image light may increase a field of view (FOV) of the displayed content (e.g., images). For example, the FOV of the displayed content is such that the displayed content is presented using almost all (e.g., 120-150 degrees diagonal), and in some cases all, of the user's FOV. AR and/or MR applications may have a narrower FOV (e.g., about 40 degrees FOV). Optical subsystem 634 may be designed to correct one or more optical errors, such as, without limitation, barrel distortion, pincushion distortion, longitudinal chromatic aberration, transverse chromatic aberration, spherical aberration, comatic aberration, field curvature, astigmatism, and so forth. In some embodiments, content provided to electronic display panel(s) 628 for display is pre-distorted, and optical subsystem 634 corrects the distortion when it receives image light from electronic display panel(s) 628 generated based on the content.

The HMD system 600 may further include an eye tracking system 636. A camera 624 or other optical sensor inside HMD 100 may capture image information of a user's eyes, and eye tracking system 636 may use the captured information to determine interpupillary distance, interocular distance, a 3D position of each eye relative to HMD 100 (e.g., for distortion adjustment purposes), including a magnitude of torsion and rotation (i.e., roll, pitch, and yaw) and gaze directions for each eye. In one example, infrared light is emitted within HMD 100 and reflected from each eye. The reflected light is received or detected by a camera 624 of the HMD 100 and analyzed to extract eye rotation from changes in the infrared light reflected by each eye. Many methods for tracking the eyes of a user 106 can be used by eye tracking system 636. Accordingly, eye tracking system 636 may track up to six degrees of freedom of each eye (i.e., 3D position, roll, pitch, and yaw) and at least a subset of the tracked quantities may be combined from two eyes of a user 106 to estimate a gaze point (i.e., a 3D location or position in the virtual scene where the user is looking). For example, eye tracking system 636 may integrate information from past measurements, measurements identifying a position of a user's 106 head, and 3D information describing a scene presented by electronic display panel(s) 628. Thus, information for the position and orientation of the user's 106 eyes is used to determine the gaze point in a virtual scene presented by HMD 100 where the user 106 is looking.

The HMD system 600 may further include a head tracking system 638. The head tracking system 638 may leverage one or more of the sensors 626 (e.g., the IMU(s) 110) and/or the camera(s) 624 to track head motion, including head rotation, of the user 106, as described above. For example, the head tracking system 638 can track up to six degrees of freedom of the HMD 100 (i.e., 3D position, roll, pitch, and yaw). These calculations can be made at every frame of a series of frames so that an application 614 (e.g., a video game) can determine how to render a scene in the next frame in accordance with the head position and orientation. In some embodiments, the head tracking system 638 is configured to predict a future position and/or orientation of the HMD 100 based on current and/or past data. This is because an application 614 is asked to render a frame before the user 106 actually sees the light (and, hence, the image) on the display(s) 628. Accordingly, a next frame can be rendered based on this future prediction of head position and/or orientation that was made at an earlier point in time, such as roughly 25-30 milliseconds (ms) prior to rendering the frame. In a distributed HMD system 600 where a separate computer 602 is communicatively (e.g., wirelessly) coupled to the HMD 100, the future prediction of the head pose may be made 30 ms or more in advance of the illumination time for the frame to account for network latency, compression operations, etc. Rotation data provided by the head tracking system 638 can be used to determine both direction of HMD 100 rotation, and amount of HMD 100 rotation in any suitable unit of measurement. For example, rotational direction may be simplified and output in terms of positive or negative horizontal and positive or negative vertical directions, which correspond to left, right, up, and down. Amount of rotation may be in terms of degrees, radians, etc. Angular velocity may be calculated to determine a rate of rotation of the HMD 100. As discussed above in detail, the force canceling speaker transducers 102 of the HMD 100 mitigate vibrations that would otherwise propagate through the housing 104 of the HMD 100 to make head tracking more accurate (e.g., by “cleaning up” the data generated by the IMU(s) 110) and to enable jitter-free video rendering on the display panel(s) 628.

The HMD system 600 may further include a hand tracking system 640. The hand tracking system 640 may leverage one or more of the sensors 626 and/or the camera(s) 624 to track controller motion (e.g., the motion of the handheld controller(s) 108 depicted in FIG. 1). For example, the hand tracking system 640 can track up to six degrees of freedom of the controllers 108 the user 106 holds in his/her hands (i.e., 3D position, roll, pitch, and yaw). These calculations can be made at every frame of a series of frames so that an application 614 (e.g., a video game) can determine how to render virtual controllers and/or virtual hands in a scene in the next frame in accordance with the controller position(s) and orientation(s). In some embodiments, the hand tracking system 640 is configured to predict a future position and/or orientation of the controller(s) 108 based on current and/or past data, as described above with respect to the head tracking system 638.

As mentioned above, in some examples, a signal processing algorithm may be used in lieu of, or in addition to, the force canceling speaker transducers 102 described herein to mitigate the interference from the speaker transducers of the HMD 100 during audio output by removing any portion of the IMU-generated data that is attributable to vibrations generated by the speaker transducers. Since the electrical signals input to, and the movement of, the speaker transducers are known, the effect of the speaker transducers can be subtracted or otherwise removed from the IMU-generated data based on these known parameters. In some examples, a signal processing algorithm may be performed by the processor(s) 604 executing the tracking component(s) 616 and/or the rendering component(s) 618. In some examples, the processor(s) 604 may monitor the activity of the speaker transducer(s) 102 and generate corresponding data corresponding to the audio signals. In some examples, the processor(s) 604 may perform dynamic processing on equalization (EQ) to normalize the audio signals. In some examples, the processor(s) 604 may use a transfer function to convert the audio signal data to characterize the effect of the audio signal data on the IMU-generated data in terms of vibration caused by the speaker transducer(s) 102. In some examples, the processor(s) 604 takes into account that the speaker transducer(s) 102 performs differently at different frequencies, which may result in a frequency dependent transfer function. In some examples, the transfer function may be non-linear to account for different transfer functions at different volume levels. In some examples, the transfer function may include variables that account for the energy that is transferred through plastic, screws, and/or wires in the housing 104 of the HMD 100, and/or multiple paths through the housing 104. In some examples, the transfer function may include variables that account for the time it takes for vibrations to travel from the speaker transducer(s) 102 to the IMU(s) 110, which might be different for different frequencies of audio output. In some examples, the processor(s) 604 cancels the effects of the speaker transducer(s) 102 on the IMU-generated data at the particular times, which may include synchronizing the respective clocks associated with the speaker transducer(s) 102 and the IMU(s) 110. That is, the processor(s) 604 may synchronize the clocks between the audio output and the IMU algorithm if they don't share the same clock and/or if they operate independently of one another.

FIG. 7 is a diagram of an example signal processing approach that can be used in addition to, or in lieu of, the disclosed force canceling speaker transducers for mitigating, if not eliminating, the interference from the speaker transducers during audio output, in accordance with embodiments disclosed herein. The HMD system 600 (e.g., a computer 602 (e.g., a host computer), the HMD 100, etc.) has knowledge of the audio signal 700 that is transmitted to the speaker transducers 102 and the input vibrations from the IMU(s) 110 (e.g., as detected by one or more vibration sensitive sensors 702, such as an accelerometer(s), a gyroscope(s), etc.). Therefore, the audio-to-IMU transfer function can be directly computed using either the Cross Spectrum between the output and input divided by the Auto Spectrum of the input, or by the Auto Spectrum of the output divided by the Cross Spectrum between the output and input. The input is defined as the audio signal 700 and the output is defined by the IMU 110 measurement. In the frequency region where the Coherence is high, nominally between 0.8 and 1, a cancellation filter can be generated and applied (e.g., via the audio-to-IMU cancellation signal 704) to remove the audio-to-IMU contamination signal 706, or at least attenuate it below a threshold of perceptibility. This cancellation filter may include an infinite impulse response (IIR) filter (e.g., notch, peaking biquad, high-pass, low-pass, bandpass, phase shift, etc.), a finite impulse response (FIR) filter, or a combination thereof, with compensation for propagation and processing latencies. The following Equations (1) and (2) are examples of the transfer functions described herein:

$${H}_{x y} = \frac{{G}_{x y}}{{G}_{x x}} \qquad ( 1 )$$

$${H}_{x y} = \frac{{G}_{y y}}{{G}_{x y}} \qquad ( 2 )$$

The following Equation (3) is an example of a coherence equation that can be used in the signal processing approach described herein:

$${C}^{2} = \frac{{\vert {G}_{x y} \vert}^{2}}{{G}_{x x} {G}_{y y}} \qquad ( 3 )$$

The device vibration contamination (e.g., the audio-to-IMU contamination signal 706) is substantially linear time invariant as the speaker transducers 102 and the IMU(s) 110 are mounted at fixed locations in the device housing 104. However, over time the transfer function (e.g., Equation (1) or Equation (2)) between the speaker transducers 102 and IMU(s) 110 may change due to effects such as system aging, sensor drift, handling, and/or damage. The transfer function can be updated dynamically. For example, when the device (e.g., the HMD 100) is stationary, but still registers motional jitter in the presence of audio signals, changes in jitter error signal can be used to converge on better cancellation. The method of convergence may be based on least mean square, machine learning, pull from a bank of pre-computed filters, other use technique as is consistent with the compute available on the system (e.g., the HMD system 600, the computer 602 (e.g., host computer), the HMD 100, etc.). Additionally, characteristic motion with and without the presence of the audio signal 700 can be used to monitor the cancellation filter or dynamically modify it over time. For example, the system can use a history of head motion within the HMD 100 and drift from expected trajectories, or through direct intervention by the user 106 in response to a guided calibration process. In the condition where the audio output 708 from the speaker transducers 102 is non-linear due to electrical, mechanical, and/or magnetic limitations or due to dynamic signal processing, these differences can be characterized and monitored through voltage and/or current sensing in the amplifier and be compensated for in the algorithm.

The audio-to-IMU vibration (e.g., the audio-to-IMU contamination signal 706) may occur exclusively with certain types of signals. Therefore, it may be possible to turn the signal processing cancellation on and off dynamically to save computing resources (e.g., processing resources, memory resources, power resources (e.g., battery power), etc.), or to allow a tracking algorithm 710 to operate with a simpler and potentially lower latency mode without the presence of these audio signals 700, and transition to a lower confidence from the IMU mode when these signals are present. For example, if there is contention between non-vibration sensitive sensors and the IMU 110, the presence or lack of presence of audio signals 700 can be used to weight the contribution to tracking algorithm 710.

As mentioned above, although the examples described herein pertain to a HMD 100, it is to be appreciated that the force canceling speaker transducers can be implemented in any electronic device with an IMU(s) mounted in the housing of the electronic device. In some examples, the force canceling speaker transducers described herein can be implemented in other types of electronic devices without an IMU(s) for reducing the vibrations caused by the speaker transducers. Examples of other types of electronic devices that may benefit from implementing the force canceling speaker transducers described herein include handheld controllers (e.g., gaming controllers, both two-handed and single-handed controllers, such as VR controllers), headphones (e.g., both single-ear and two-ear headphones), and/or similar types of electronic devices regardless of whether they use an IMU(s) for tracking. Such an electronic device may include: a housing; a first speaker transducer and a second speaker transducer mounted in the housing, the first speaker transducer having a front side facing a first on-axis direction that is fixed relative to the housing, and the second speaker transducer having a front side facing a second on-axis direction that is fixed relative to the housing and that is rotated relative to the first on-axis direction by a first angle within a range of about 120 to 240 degrees.

The foregoing may also be understood in view of the following clauses:
1. A head-mounted display (HMD) system comprising:
a HMD comprising:
   a housing;
   one or more speaker transducers mounted in the housing; and
   an inertial measurement unit (IMU) mounted in the housing;
a processor; and
memory storing computer-executable instructions that, when executed by the processor, cause the processor to:
   generate, using a transfer function, a cancellation filter based at least in part on an audio signal provided to the one or more speaker transducers; and
   apply the cancellation filter to data generated by the IMU to attenuate a portion of the data that is attributable to vibrations generated by the one or more speaker transducers during audio output from the one or more speaker transducers.
2. The HMD system of clause 1, wherein applying the cancellation filter to the data to attenuate the portion of the data comprises removing the portion of the data from the data.
3. The HMD system of clause 1 or 2, wherein the transfer function is a frequency dependent transfer function.
4. The HMD system of any one of clauses 1 to 3, wherein the transfer function is non-linear.
5. The HMD system of any one of clauses 1 to 4, wherein the instructions, when executed by the processor, further cause the processor to synchronize respective clocks associated with the one or more speaker transducers and the IMU.

Unless otherwise indicated, all numbers expressing quantities used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A head-mounted display (HMD) comprising:
a housing having a left side and a right side, the left side of the housing configured to be disposed at a left side of a head of a user of the HMD and the right side of the housing configured to be disposed at a right side of the head;
an inertial measurement unit (IMU) mounted in the housing and configured to generate data based on electrical signals received from at least one of an accelerometer or a gyroscope, wherein the data is usable for tracking the HMD;
a first pair of speaker transducers mounted in the housing at the left side of the housing for emitting sound for a left ear of the user, the first pair of speaker transducers comprising:
a first speaker transducer having a front side facing a first on-axis direction that is fixed relative to the housing; and
a second speaker transducer having a front side facing a second on-axis direction that is fixed relative to the housing and that is rotated relative to the first on-axis direction by a first angle within a range of about 120 to 240 degrees for cancelation of first forces generated by the first pair of speaker transducers during first audio output from the first pair of speaker transducers; and
a second pair of speaker transducers mounted in the housing at the right side of the housing for emitting sound for a right ear of the user, the second pair of speaker transducers comprising:
a third speaker transducer having a front side facing a third on-axis direction that is fixed relative to the housing; and
a fourth speaker transducer having a front side facing a fourth on-axis direction that is fixed relative to the housing and that is rotated relative to the third on-axis direction by a second angle within the range of about 120 to 240 degrees for cancelation of second forces generated by the second pair of speaker transducers during second audio output from the second pair of speaker transducers.

2. The HMD of claim 1, wherein:
the first angle is within a range of about 145 to 155 degrees; and
the second angle is within the range of about 145 to 155 degrees.

3. The HMD of claim 1, wherein:
the housing comprises a first baffle at the left side of the housing and a second baffle at a right side of the housing;
the first pair of speaker transducers are mounted to the first baffle; and
the second pair of speaker transducers are mounted to the second baffle.

4. The HMD of claim 1, wherein:
the first pair of speaker transducers are configured to emit sound for the left ear through a first sound exit defined in the housing; and
the second pair of speaker transducers are configured to emit sound for the right ear through a second sound exit defined in the housing.

5. The HMD of claim 1, wherein the first pair of speaker transducers and the second pair of speaker transducers are each configured to emit sound at frequencies within a range of about 100 to 20,000 Hertz (Hz).

6. The HMD of claim 1, wherein the HMD is a virtual reality (VR) headset configured to render images based on a pose of the HMD determined at least in part using the IMU.

7. A head-mounted display (HMD) comprising:
a housing; and
a first speaker transducer and a second speaker transducer mounted in the housing, the first speaker transducer having a front side facing a first on-axis direction that is fixed relative to the housing, and the second speaker transducer having a front side facing a second on-axis direction that is fixed relative to the housing and that is rotated relative to the first on-axis direction by a first angle within a range of about 120 to 240 degrees.

8. The HMD of claim 7, further comprising an inertial measurement unit (IMU) mounted in the housing.

9. The HMD of claim 7, wherein:
the first angle is within a range of about 145 to 155 degrees.

10. The HMD of claim 7, wherein:
the housing comprises a baffle; and
the first speaker transducer and the second speaker transducer are mounted to the baffle.

11. The HMD of claim 7, wherein:
the first speaker transducer and the second speaker transducer are configured to emit sound through a sound exit defined in the housing.

12. The HMD of claim 7, wherein the first speaker transducer, and the second speaker transducer are each configured to emit sound at frequencies within a range of about 100 to 20,000 Hertz (Hz).

13. The HMD of claim 7, wherein the HMD is a virtual reality (VR) headset configured to render images based on a pose of the HMD determined at least in part using an inertial measurement unit (IMU) mounted in the housing.

14. A head-mounted display (HMD) comprising:
a housing; and
a first speaker driver and a second speaker driver mounted in the housing, the first speaker driver having a first axis of motion that is directed away from a front side of the first speaker driver in a first on-axis direction that is fixed relative to the housing, and the second speaker driver having a second axis of motion that is directed away from a front side of the second speaker driver in a second on-axis direction, wherein a first angle between the first on-axis direction and the second on-axis direction is within a range of about 120 to 240 degrees.

15. The HMD of claim 14, wherein:
the first angle is within a range of about 175 to 185 degrees.

16. The HMD of claim 14, further comprising an inertial measurement unit (IMU) mounted in the housing.

17. The HMD of claim 14, wherein:
the housing comprises a baffle; and
the first speaker driver and the second speaker driver are mounted to the baffle.

18. The HMD of claim 14, wherein:
the first speaker driver and the second speaker driver are configured to emit sound through a sound exit defined in the housing.

19. The HMD of claim 14, wherein the first speaker driver, and the second speaker driver are each configured to emit sound at frequencies within a range of about 100 to 20,000 Hertz (Hz).

20. The HMD of claim 14, further comprising:
an inertial measurement unit (IMU) mounted in the housing; and
one or more display panels configured to display a series of images representing video content, wherein the series of images are rendered based on a pose of the HMD determined at least in part using the IMU.

21. A HMD system comprising:
the HMD of claim 16;
a processor; and
memory storing computer-executable instructions that, when executed by the processor, cause the processor to:
generate, using a transfer function, a cancellation filter based at least in part on an audio signal provided to the first speaker driver and to the second speaker driver; and
apply the cancellation filter to data generated by the IMU to attenuate a portion of the data that is attributable to vibrations generated by the first speaker driver and the second speaker driver during audio output from the first speaker driver and from the second speaker driver.
